(19) United States
(12) Patent Application Publication
(10) Pub. No.: US 2015/0104567 A1
(43) Pub. Date: Apr. 16, 2015

(54) METHOD FOR FORMING A FUNCTIONAL PATTERN ON A SUBSTRATE

(71) Applicant: Korea Advanced Institute of Science and Technology, Daejeon (KR)

(72) Inventors: Seung Seob LEE, Daejeon (KR); Jin Ha Kim, Daejeon (KR); Hun Kwang Im, Daejeon (KR)

(73) Assignee: Korea Advanced Institute of Science and Technology, Daejeon (KR)

(21) Appl. No.: 14/303,712

(22) Filed: Jun. 13, 2014

(30) Foreign Application Priority Data
Oct. 15, 2013 (KR) 10-2013-0122341

(51) Int. Cl. H01B 13/00

(52) U.S. Cl. CPC H01B 13/0026; H01B 13/0016
USPC 427/125; 427/259; 427/58

(57) ABSTRACT

A method for forming a functional pattern such as an electrode or the like on a substrate is provided. The method includes a) coating a polymer layer on an upper surface of the substrate, b) forming a pattern having an opening in the polymer layer, c) coating a functional fluid on the upper surface of the substrate through the opening of the pattern, d) removing the functional fluid coated on the polymer layer using a scraping process, e) curing the functional fluid through a heat treatment, and f) dissolving and removing the polymer layer using a solvent. The present method is capable of forming a functional pattern having a small line width and a clear shape.

### FIELD OF THE INVENTION

The present invention relates to a method for forming a functional pattern such as an electrode or the like on a substrate and, more particularly, to a functional pattern forming method in which a functional pattern having a fine line width is formed by removing a polymer sacrificing layer for pattern formation.

### BACKGROUND ART

A touch screen panel is a computing input device that, upon touching a screen with a finger or a pen, recognizes and inputs the coordinates thus touched. In recent years, there are developed touch screen panels of different types and structures. The touch screen panels are used in a wide range of fields, e.g., mobile phones such as a smart phone and a cellular phone, PDAs (Personal Digital Assistants), PMPs (Portable Multimedia Players), ATMs (Automatic Teller Machines), POS (Point of Sales) systems, search guide systems, unmanned contract terminals and game machines.

A touch screen panel essentially includes a touch panel, a controller, and driver software. The touch panel is composed of an upper plate and a lower plate on which a transparent conductive film, e.g., an ITO (Indium Tin Oxide) film, is deposited. If the surface of the touch panel is physically touched, the upper plate and the lower plate make contact with each other at the physically touched point, thereby generating an electric signal. The electric signal is inputted to the controller. The controller converts an analog signal inputted from the touch panel to a digital signal using an A/D (Analog/Digital) converter and then transmits the digital signal to the driver software. The driver software operates the touch screen panel in response to the digital signal inputted from the controller.

A silver electrode is formed in the periphery of the touch panel. The silver electrode is invisible because it is hidden by a bezel. Recently, a touch screen panel of a smart phone is required to be larger in size while maintaining portability. Thus, the minimization of the size of the bezel becomes a critical issue.

As example of a method for forming a silver electrode in the periphery of a touch screen panel, there are available many different methods such as photolithography, ink-jet printing, stencil printing and gravure printing. A method for forming a fine silver electrode by chemical etching using photolithography may cause chemical damage to a touch panel coated with ITO (Indium Tin Oxide). Moreover, the performance of a surface electrode may be reduced due to a heat treatment required in a lithography process. For that reason, it is difficult to form a silver electrode using a lithography process.

A method for forming a silver electrode through the use of ink-jet printing shows low accuracy with respect to a repetitive pattern and entails a lot of restrictions in realizing a fine line width of 100 μm or less. In particular, a high-viscosity silver ink should be used in order to form a highly conductive electrode applied to a touch panel. However, the ink-jet-based silver ink printing method involves many difficulties in transferring a high-viscosity silver ink pattern.

Stencil printing can solve a chemical problem, a thermal problem and a problem caused by the high viscosity of a silver ink. However, the stencil printing has a limit in reducing a silver ink line width. Accordingly, it is quite difficult for the stencil printing to realize a fine line width of 80 μm or less in a widespread touch panel.

Gravure printing that makes use of a polymer mold is suitable for use in a continuous process. However, in case of applying the gravure printing to a silver ink having a high viscosity of 30,000 cP (Centipoise) or more, due to the characteristics of a continuous process using a roll printing method, it is difficult to fill the ink into a mold or to apply a pressure in a transfer process. For that reason, the gravure printing is not suitable for use in a high-viscosity silver ink process.

As prior art documents, reference is made to Korean Patent Application Publication Nos. 2013-0067181 and 2007-0002388.

### SUMMARY OF THE INVENTION

In view of the above-noted problems inherent in the related art, it is an object of the present invention to provide a novel method capable of forming a functional pattern having a small line width and a clear shape on a substrate.

In one aspect of the present invention, there is provided a method for forming a functional pattern on a substrate, including the steps of: a) coating a polymer layer on an upper surface of the substrate; b) forming a pattern having an opening in the polymer layer; c) coating a functional fluid on the upper surface of the substrate through the opening of the pattern; d) removing the functional fluid coated on the polymer layer using a scraping process; e) curing the functional fluid through a heat treatment; and f) dissolving and removing the polymer layer using a solvent.

In the method, the step b) may be performed using an embossing process. The substrate may be made of a transparent material. The functional fluid may be a conductive composition or a photo-functional composition. The conductive composition may be selected from the group consisting of a silver ink, a copper ink and a carbon nano tube ink.

According to the present method for forming a functional pattern on a substrate, it is possible to form a functional pattern having a small line width and a clear shape. This makes it possible to form an electrode having a small line width in the course of forming a silver electrode for an existing touch panel. Moreover, it is possible to perform a touch panel manufacturing process at a relatively low temperature. Accordingly, when manufacturing a touch display, a new process can be easily applied without hindering the existing process. This makes it possible to reduce the unit cost of a process. In addition, the bezel width of a display can be made smaller by reducing the line width. It is therefore possible to manufacture a device having a wider touch display screen with the overall device size remaining the same.

### BRIEF DESCRIPTION OF THE DRAWINGS

The above and other objects and features of the present invention will become apparent from the following description of preferred embodiments, given in conjunction with the accompanying drawings.

FIGS. 1 to 7 are schematic diagrams illustrating different steps of a method for forming a functional pattern on a substrate according to one embodiment of the present invention.

### DETAILED DESCRIPTION OF THE PREFERRED EMBODIMENTS

One preferred embodiment of the present invention will be described in detail with reference to the accompanying drawings. The embodiment to be described below is presented by way of example in an effort to sufficiently transfer the concept of the present invention to those skilled in the relevant art. Therefore, the present invention is not limited to the following embodiment but may be embodied in many other forms. In the accompanying drawings, the width, length and thickness of the components may be illustrated on an exaggerated scale for the sake of convenience. Throughout the specification and the drawings, the same components will be designated by like reference numerals.

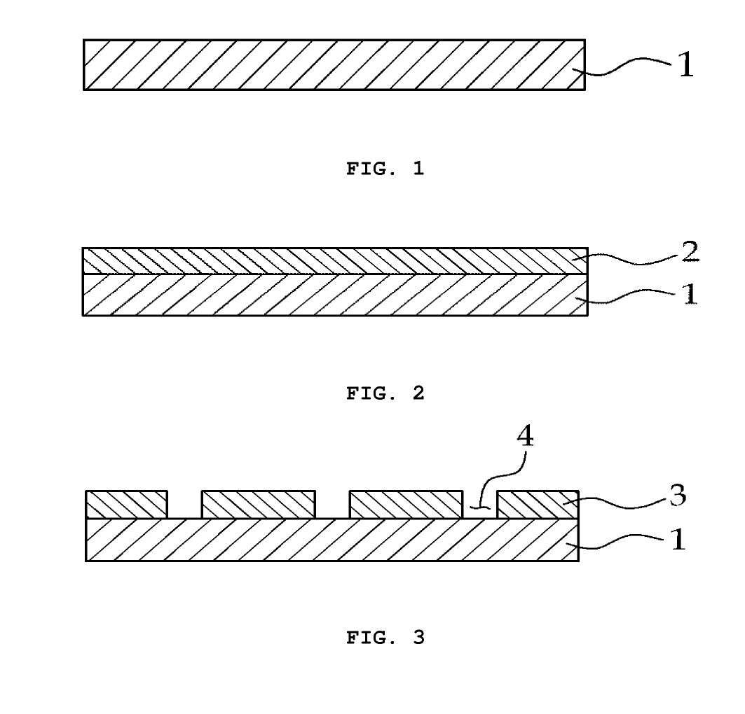

FIGS. 1 to 7 are schematic diagrams illustrating different steps of a method for forming a functional pattern on a substrate according to one embodiment of the present invention.

The embodiment described with reference to FIGS. 1 to 7 is directed to a process in which an electrode pattern is formed by a silver paste as one example of a functional fluid. However, the present invention is not limited thereto but may be applicable to all kinds of processes for forming a pattern on a substrate.

As shown in FIG. 1, a substrate 1 is first prepared. It is preferred that the substrate 1 is made of a transparent material such as glass, polycarbonate (PC), polyethyleneterephthalate (PET) or the like.

Next, as illustrated in FIG. 2, a photoresist layer 2 as a polymer layer is coated on the substrate 1. A photoresist may be used as the polymer layer. For example, it is possible to use AZ5214 or AZ9260, a positive resist which is decomposed or softened by the light. It may also be possible to use a negative resist. The photoresist layer 2 can be coated on the surface of the substrate 1 at a uniform thickness by a variety of methods such as spin coating, roller coating, screen printing, dispensing, and the like.

Subsequently, as shown in FIG. 3, the photoresist layer 2 is subjected to patterning. The photoresist layer 2 is exposed to the light passing through a window of a mask. If the exposed photoresist layer 2 is developed, a photoresist pattern 3 is formed by the photoresist remaining on the surface of the substrate 1. As depicted in FIG. 3, openings 4 are formed in the photoresist pattern 3. After developing the photoresist layer 2, descumming may be additionally implemented in order to remove the remaining scum.

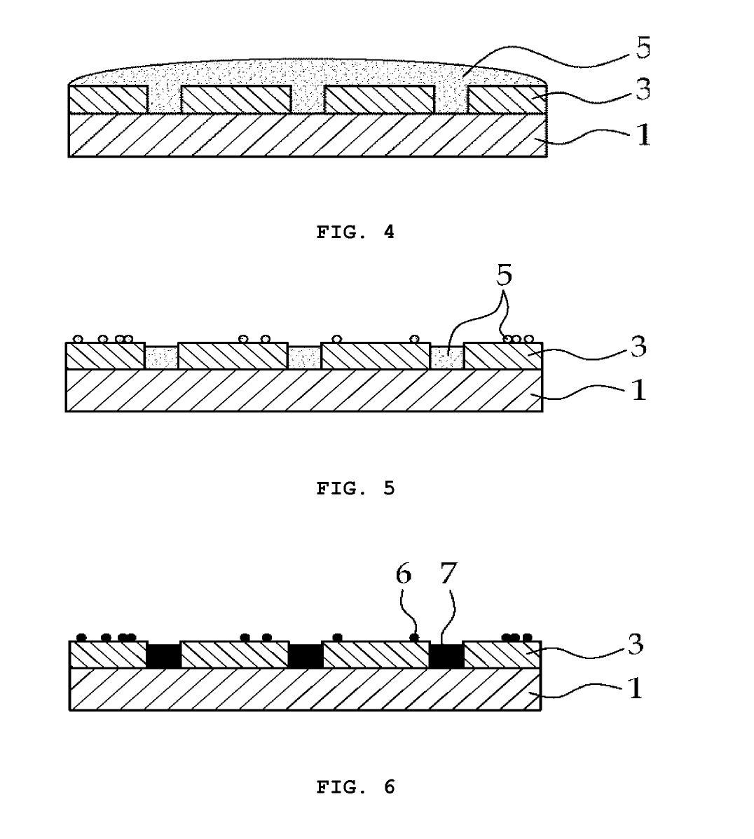

Then, as illustrated in FIG. 4, a silver ink 5 as a functional fluid is coated on the upper surface of the substrate 1 through the openings 4 of the photoresist pattern 3. In order to assure that the silver ink 5 having a high viscosity can be uniformly coated on the upper surface of the substrate 1 through the openings 4, the silver ink 5 is uniformly filled into the openings 4 by applying a pressure to the silver ink 5 or by applying a shock or vibration to the substrate 1. The silver ink 5 may be pressed through the use of a roller. The silver ink 5 may be uniformly filled into the openings 4 by pressing a polymer film or a glass substrate against the surface of the silver ink 5.

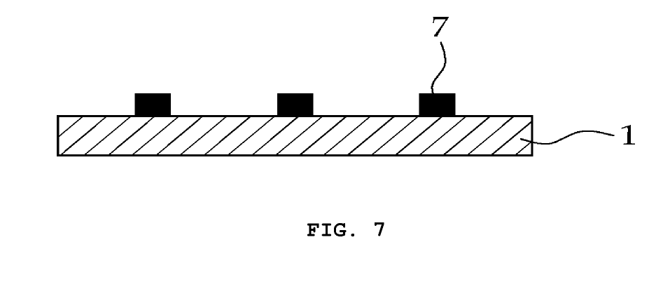

Thereafter, as shown in FIG. 5, the silver ink 5 coated on the photoresist pattern 3 is removed through a scraping process. The silver ink 5 is removed by a scraping operation that makes use of a squeegee, a scraper, a doctor blade or the like. If the surface of the photoresist pattern 3 is scraped by the squeegee, the silver ink 5 is removed from the surface of the photoresist pattern 3.

Then, as illustrated in FIG. 6, the coated silver ink 5 is cured through a heat treatment in order to prevent the silver ink 5 from getting damaged in the subsequent steps. The curing is performed at a temperature at which the photoresist pattern 3 used as a mold does not undergo a chemical change.

Finally, as shown in FIG. 7, if the photoresist pattern 3 is dissolved using a solvent, the cured silver ink 6 not removed in the scraping process but left on the upper surface of the photoresist pattern 3 is removed. By removing the photoresist pattern 3 and the remaining silver ink 6, it is possible to obtain a substrate on which a clear electrode pattern 7 is formed.

While one preferred embodiment of the present invention has been described above, the present invention is not limited to this embodiment. It will be apparent to those skilled in the art that various changes, modifications and substitutions may be made without departing from the technical concept of the invention and the scope of the invention defined in the claims. Such changes, modifications and substitutions shall be construed to fall within the scope of the invention.

The above description has been made by taking the silver ink as an example of the functional fluid. Alternatively, the functional fluid may be other conductive compositions or photo-functional compositions. Not only the silver ink but also a copper ink, a carbon nano tube ink or the like may be used as the conductive compositions.

Moreover, the above description bas been made on a case where the photoresist layer is used as a polymer layer and where photolithography is used as a method for forming a polymer layer pattern. Alternatively, the polymer layer pattern may be formed by an embossing process.

What is claimed is:

1. A method for forming a functional pattern on a substrate, comprising the steps of:
a) coating a polymer layer on an upper surface of the substrate;
b) forming a pattern having an opening in the polymer layer;
c) coating a functional fluid on the upper surface of the substrate through the opening of the pattern;
d) removing the functional fluid coated on the polymer layer using a scraping process;
e) curing the functional fluid through a heat treatment; and
f) dissolving and removing the polymer layer using a solvent.

2. The method of claim 1, wherein the step b) is performed using an embossing process.

3. The method of claim 1, wherein the substrate is made of a transparent material.

4. The method of claim 1, wherein the functional fluid is a conductive composition or a photo-functional composition.

5. The method of claim 4, wherein the conductive composition is selected from the group consisting of a silver ink, a copper ink and a carbon nano tube ink.
